(19) United States
(12) Patent Application Publication
(10) Pub. No.: US 2009/0217591 A1
(43) Pub. Date: Sep. 3, 2009

(54) Safety Gate With Attached Toe Board

(76) Inventor: David LaCook, Houston, TX (US)

Correspondence Address: TIM COOK, P.O. BOX 10107, LIBERTY, TX, 77575, US

(21) Appl. No.: 12/040,957

(22) Filed: Mar. 3, 2008

(51) Int. Cl. E06B 9/01

(52) U.S. Cl. 49/50

(57) ABSTRACT

An attachment is provided for a safety gate that is positioned to close the opening in a catwalk to allow access to and from a ladder or stairs. The gate is urged to the closed position by springs. The improvement is an attachment for connecting to the lower side of existing gates to prevent workmen using the catwalk from slipping under the gate and falling into the opening for stairs or a ladder.

### FIELD OF THE INVENTION

This invention relates generally to the field of safety gates commonly mounted on catwalks, walkways, and the like, and more particularly to a toe board attachment for improving the safety of a gate that is used to close an opening in a guard rail of a walkway for ladders and stairs leading to and from the walkway.

### BACKGROUND OF THE INVENTION

In a typical industrial plant, there are walkways and catwalks from which a worker could fall to a lower level. For safety's sake, these walkways are usually provided with guard rails to help prevent a worker from accidentally stepping off the side of the walkway and falling. Guard rails also often include a toe board to prevent tools and other items from falling off the walkway. For various reasons, however, it is necessary to provide openings in the guard rails. For example, one or more ladders or stairs may lead from the walkway to another level. Openings are provided in the guard rails so that one can move from the ladders or stairs onto the walkway and vice versa. Such openings in the guard rails are a danger to personnel using the walkway.

U.S. Pat. No. 3,866,356 described a safety gate specifically designed to keep personnel from inadvertently falling from the walkway into the openings for the stairs or ladders, hereinafter “stairwells”. The safety gate of the '356 patent has enjoyed tremendous commercial success and can be found throughout the industrial world protecting workers from inadvertently falling through the stairwells in catwalks.

The gate of the '356 patent is positioned approximately waist high to an average size worker standing on the catwalk. As a result, there exists an opening between the gate and the catwalk through which it is possible for a worker to slide under the gate into the stairwell. No such accident has been reported to date although these gates have been in use throughout the world for many years.

Nevertheless, an attachment for these gates extending the gate downwardly to a position closer to the catwalks reduces the chances of a worker slipping under the gate into a stairwell. This improvement was shown and described in U.S. Pat. No. 6,094,863. However, the attachment of the '863 patent left a gap between the bottom of the attachment and the upper surface of the walkway. That gap has sometimes provided an egress for tools and other objects, which can then fall down the stairwell and perhaps strike a worker below the gate. Thus, there remains a need for a toe board which extends the bottom of the gate to a position close to the top surface of the walkway. The toe board attachment described herein fulfills this and other needs in the art.

### SUMMARY OF THE INVENTION

The safety gate and its attachment described herein provides a toe board which may be attached during manufacture of the gate, or it may be attached as a retrofit to a gate that is already installed. The attachment comprises a pair of spaced-apart mounting adapters, preferably in the form of loops of a flat plate workpiece, to which vertical supports are secured. A butt plate is mounted to the vertical supports, and the butt plate preferably includes two or more joining holes so that the attachment may be secured to one of several widths of safety gate. The safety gate also includes an adjustable plate so that the safety gate may be mounted in line with a hand rail or perpendicular to the hand rail.

These and other objects, advantages, and features of this invention will be apparent to those skilled in the art from a consideration of this specification, including the attached drawings and appended claims.

### BRIEF DESCRIPTION OF THE DRAWINGS

FIG. 1 is a perspective view of a safety with an attached toe board.

FIG. 2 is a rear view of a toe board and a presently preferred structure of attaching the toe board to a safety gate.

FIG. 3 is a side view in partial section of a presently preferred attaching structure for mounting a toe board to a gate.

FIG. 4 is a top view of a toe board strike plate, enabling the toe board to be attached to safety gates of various sizes.

FIG. 5 is a perspective view of a reversible butt plate, enabling the safety gate to be attached in-line with a hand rail or perpendicular to the hand rail, simply by reversing the butt plate.

FIG. 6 is a top view of the butt plate of FIG. 5, depicting the closure biasing means of the safety gate.

### DETAILED DESCRIPTION OF PREFERRED EMBODIMENTS

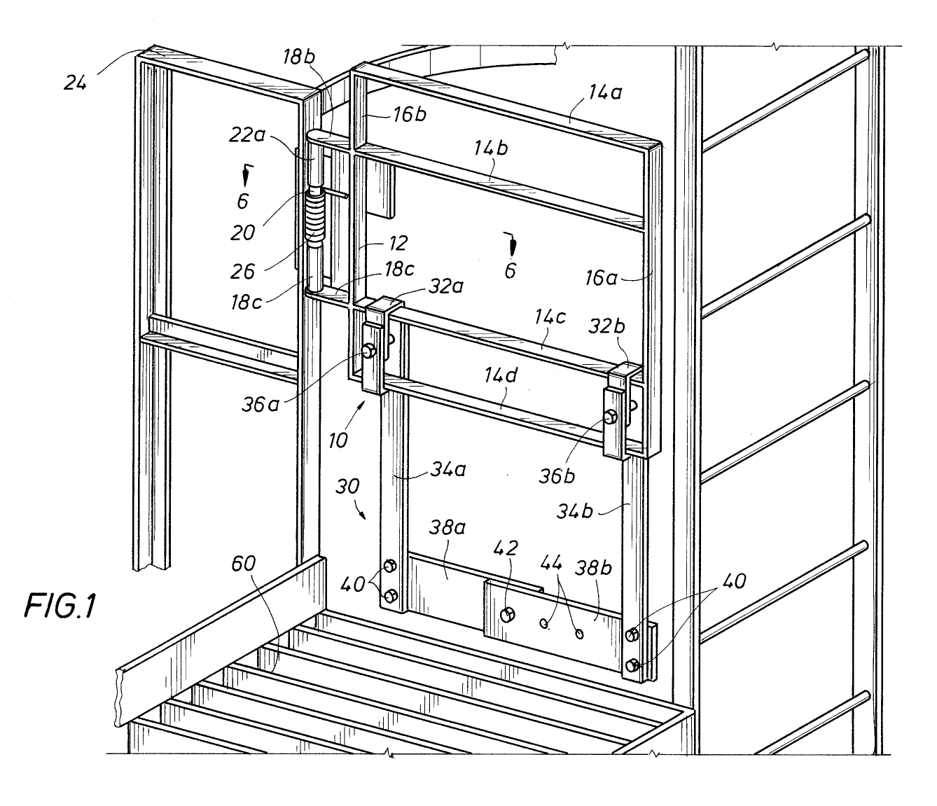

FIG. 1 depicts a gate 10 comprising a frame 12 having horizontal members 14a, 14b, 14c, and 14d. In an alternative embodiment, the frame 12 may include more or fewer horizontal members, but in no case fewer than two such members, as will be explained in further detail below. The horizontal members are joined by a first vertical plate 16a and a second vertical plate 16b to form a substantially rigid frame 12, capable of withstanding normal wear and tear of a safety gate. The frame 12 is preferably formed from an elongated flat plate about two inches wide that is bent into the shape shown in FIG. 1, and then the additional members welded to the bent form.

The horizontal member 14b extends to define a horizontal extension 18b and the horizontal member 14c extends to define a horizontal extension 18c. An axle 20 spans the space between the extensions 18b and 18c and the axle 20 is rotatably held by upper and lower hollow tubular spacers 22a and 22b. The tubular spacers 22a and 22b are secured to a handrail 24, such as by welding, bolting, or other secure means. In this way, the safety gate 10 is operably mounted to the handrail 24. A coil spring 26 is positioned on the axle 20 between the two tubular spacers. The spring urges the gate to the closed position. In most respects, the safety gate 10 is similar to that shown and described in U.S. Pat. No. 6,094,863; assigned to the same assignee as the present improvement.

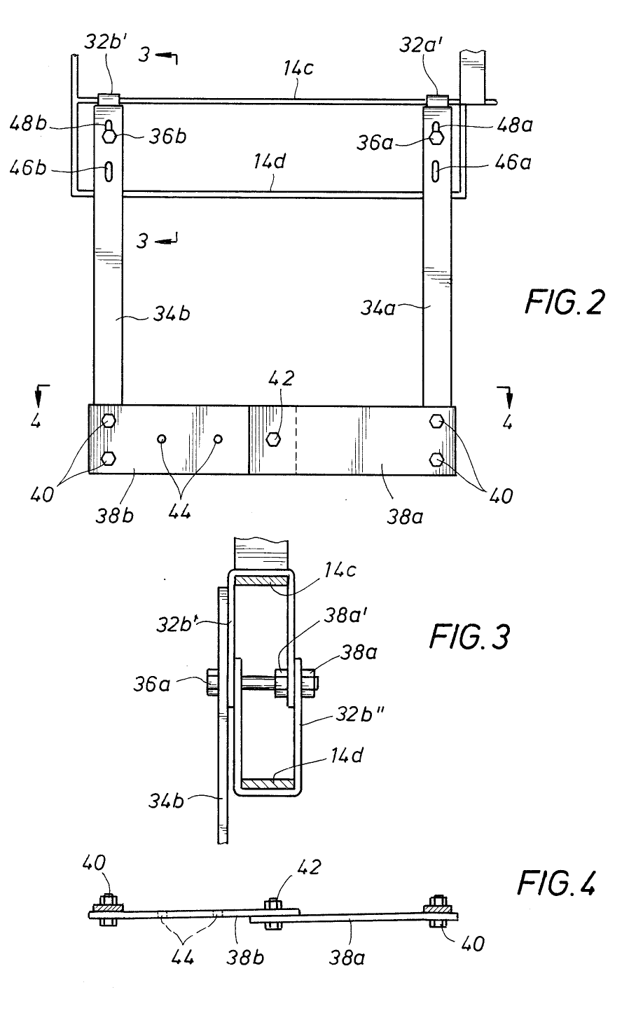

The toe board attachment of this invention is indicated in FIG. 1 by the number 30. Additional details of the attachment are shown in FIGS. 2 through 4. The toe board 30 comprises a pair of spaced-apart mounting loops 32a and 32b, each of which may be formed of a single flat of stock, roughly the same width as the horizontal members 14a, 14b, 14c, and 14d. However, as shown in FIG. 3, the mounting loop 32b is preferably formed of an upper loop section 32b′ and a lower loop section 32b″. The loop 32a is also formed of upper and lower loop section in a similar fashion. The loops 32a and 32b are illustrated in FIG. 1 as looped around the horizontal members 14c and 14d, and these loops are preferably looped around the bottom two horizontal members, however many horizontal members form the safety gate 10. Preferably, the loops are not immovably secured to the horizontal members; rather, they are slidingly mounted to the horizontal members so that the toe board 30 may be mounted to any of a varying width of gate.

Once the loops 32a and 32b are placed on the horizontal members 14c and 14d, a vertical support 34a is mounted to the loop 32a, preferably with a bolt 36a and nuts 38a and 38a′ and a vertical support 34b is mounted to the loop 32b, preferably with a bolt 36b and nuts 38b and 38b′, shown in greater detail in FIG. 3. A first butt plate 38a is secured to the vertical support 34a and a second butt plate 38b is secured to the vertical support 34b, preferably with a plurality of bolt/nut combinations 40. The butt plates 38a and 38b are jointed together with a bolt/nut combination 42, at one of a plurality of bolt holes 44. This feature enables the same elements of the attachment to be adapted to a range of widths of safety gate.

FIG. 2 shows a similar feature in respect of the height of the attachment in respect of a walkway. A first pair of elongate bolt holes 46a and 46b define a first height for the attachment above a walkway 60, while a second pair of elongate bolt holes 48a and 48b define a second height, wherein the first height is higher than the second height, providing even more flexibility for the adaptation of the safety gate to a particular installation.

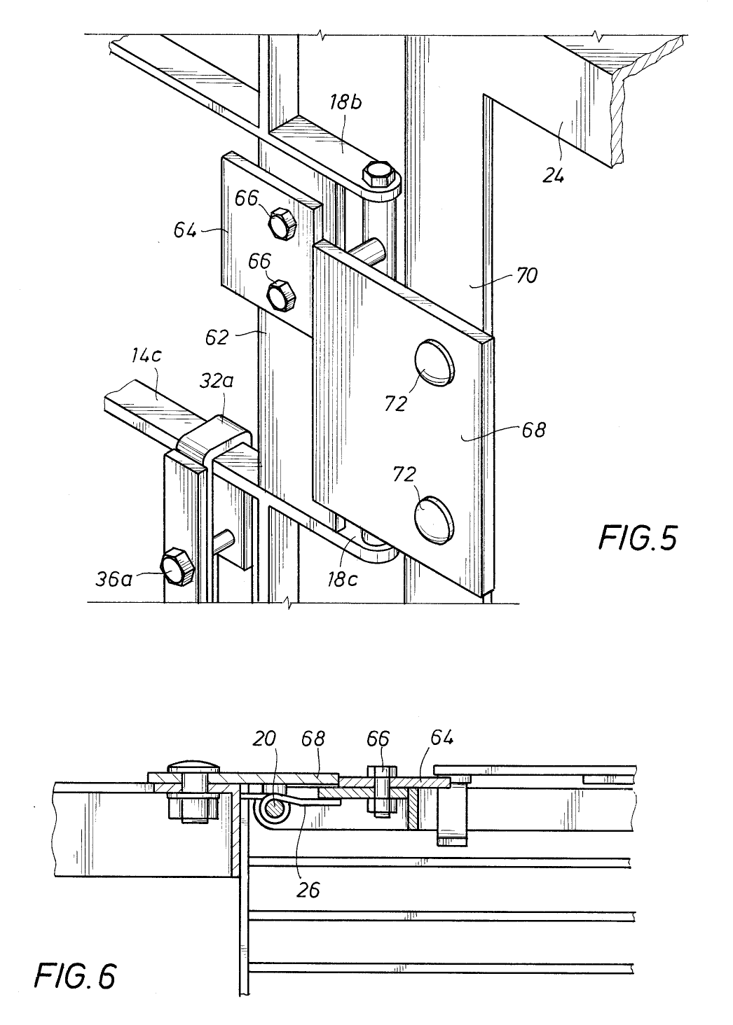

Finally, FIGS. 5 and 6 illustrate another feature of the safety gate described herein. A vertical structural member 62 extends between the horizontal extension 18b and the horizontal extension 18c. A contact plate 64 is mounted to the structural member 62, such as for example with bolts 66. Similarly, an adjustable plate 68 is mounted to a vertically depending portion 70 of the handrail 24, such as for example with bolts 72. With the adjustable plate 68 in the position as shown in FIGS. 5 and 6, the adjustable plate 68 abuts the contact plate 64 so that the rest position of the safety gate is in line with the hand rail 24. However, the bolts 72 are off center in the adjustable plate 68, so by rotating the adjustable plate by 180°, the safety gate is permitted to swing 90° out of the plane of FIG. 5, so that the safety gate is perpendicular to the hand rail 24, in applications where this orientation is desired.

From the foregoing it will be seen that this invention is one well adapted to attain all of the ends and objects hereinabove set forth, together with other advantages which are obvious and which are inherent to the apparatus and structure. It will be understood that certain features and subcombinations are of utility and may be employed without reference to other features and subcombinations. This is contemplated by and is within the scope of the claims. Because many possible embodiments may be made of the invention without departing from the scope thereof, it is to be understood that all matter herein set forth or shown in the accompanying drawings is to be interpreted as illustrative and not in a limiting sense.

1. A safety gate adapted for mounting across an opening in a hand rail, the gate comprising:
a frame having at least an upper horizontal member and a lower horizontal member and vertical members joining the upper and lower horizontal members;
means for mounting the gate to the hand rail for pivotal movement around a vertical axis;
a spring urging the gate toward a first position to maintain the gate in the first position extending across the opening to prevent passage therethrough in one direction when the gate is not forceably held in a second position, and
an attachment removably attached to and extending below the upper and lower horizontal members, the attachment comprising:
first and second loops slidably mounted in spaced apart relation around the at least two horizontal members;
a first vertical support member joined to the first loop and a second vertical support member joined to the second loop; and
first and second butt plate members joined to the first and second vertical support members, the first and second butt plate members positioned below the lower horizontal member, one of the butt plate members including a plurality of bolt holes, thereby providing an adjustment in the mounting relationship between the first and second butt plate members.

2. The safety gate of claim 1, further comprising a stop allowing the gate to pivot in only one direction from the first position to the second position, the stop including an adjustable plate to adjust the first position as required by a location of the opening.

3. The safety gate of claim 1, wherein the first loop comprises first upper and lower loop sections and the second loop comprises second upper and lower loop sections.

4. The safety gate of claim 3, wherein the first vertical support member is bolted to the first upper and lower loop sections and the second vertical support member is bolted to the second upper and lower loop sections.
